(19) United States
(12) Patent Application Publication
(10) Pub. No.: US 2008/0137330 A1
(43) Pub. Date: Jun. 12, 2008

(54) Led Device With Plural Color Chips Including at Least a Yellow Chip, a Color Image Display Utilizing the Led Device, Light For Traffic Alarm Utilizing the Color Image Display, and Traffic Alarm Utilizing the Light and Having Arrow Mark Display

(76) Inventor: Syouji Kawabe, Tokyo (JP)

Correspondence Address: KANESAKA BERNER AND PARTNERS LLP, 1700 DIAGONAL RD, SUITE 310, ALEXANDRIA, VA, 22314-2848, US

(21) Appl. No.: 11/887,256

(22) PCT Filed: Apr. 4, 2006
(86) PCT No.: PCT/JP2006/307516

§ 371 Date: Oct. 18, 2007

(30) Foreign Application Priority Data
Apr. 4, 2005 (JP) 2005-132991

(51) Int. Cl. F21V 21/00

(52) U.S. Cl. 362/231

(57) ABSTRACT

A LED device for clear emission color by a plural color chips, essentially including a yellow color chip is provided. The LED device is utilized a color image display, and by this display, a light for traffic alarm and a light for traffic alarm with arrow mark which indicates the direction are accomplished.

A LED device with plural color chips including at least a yellow chip, a color image display utilizing the LED device, light for traffic alarm utilizing the color image display, and traffic alarm utilizing the light and having arrow mark display

### DETAILED DESCRIPTION OF THE INVENTION

### Field of the Invention

This invention relates to a LED device accomplishing a clear light color with the plural color chips, and a color image display utilizing the LED device, and further this invention is to provide a traffic alarm by a single light emitting the blue color, yellow color, red color, and arrow mark direction signal, utilizing plural of the LED devices.

### BRIEF DESCRIPTION OF THE DRAWINGS

FIG. 1 is an internal front view of a LED device with blue, yellow, and red colors chips therein.

FIG. 2 is a circuit diagram of a LED device with blue, yellow, and red colors chips therein.

FIG. 3 is a front view of the LED device connected with a relay timer for emitting the device blue, yellow, red sequentially.

FIG. 4 is a circuit diagram of a relay timer for alternating the emitting colors of a light.

FIG. 5 is a front view of a traffic alarm having a relay timer for emitting blue color, yellow color, red color, and blue arrow mark sequentially.

FIG. 6 is a front view of a light in which plural LED devices are arranged, and an arrow mark is formed by the common LED device, the top of the arrow mark being projected from the circle of the light.

FIG. 7 is a front view of a light in which plural LED devices are arranged, and an arrow mark is formed inside the circle of the light.

FIG. 8 is a front view of a light showing the movement of the arrow mark of the left direction to straight and right directions.

FIG. 9 is a front view of a light showing the movement of the arrow marks of the left and straight directions to straight and right directions.

FIG. 10 is a front view of a light with two arrow marks showing straight and right directions respectively.

FIG. 11 is a rear view of a light showing the electric connection of the terminals of LED devices forming an arrow mark of left direction.

FIG. 12 is a circuit diagram for the LED devices (K·RL) (K·YL)(K·BL) arranged in the circle of a light and the LED devices (K·BL) arranged outside the circle of a light.

FIG. 13 is a front view of the LED devices mounted on the circuit board in the circle and outside of the circle of a light.

FIG. 14 is a substantially whole circuit diagram showing a magnetic relay having an open and close contacts provided inside the relay timer, connecting the relay and the light.

In drawings, 1 is a LED device, 2 is a relay timer, 3 is a light, 4 is an arrow mark, 5 is a traffic alarm, 6 is a dial for blue color, 7 is a dial for yellow color, 8 is a dial for red color, 9 is a dial for arrow mark, 10 is a circuit board, 11 is a color emission chip, 11a is a red color emission chip, 11b is a yellow color emission chip, 11c is a blue color emission chip, and 11d is a green color emission chip.

### Prior Art

One sort of conventional LED device has a red color chip, green color chip, and blue color chip, which are three primary color chips, and may colors are emitted by the mixture of three primary color with a singular device.

By the way, a traffic alarm has three light, i.e., blue light, yellow light, red light, and further may include blue arrow mark light. Hence the alarm is provided with plural lights. When LED device is used in the traffic alarm light, respective light emits single color. Accordingly three kind of lights are required for emitting blue light, yellow light, and red light.

### Subjects Solved by Invention

By the prior conventional device, the yellow color must be emitted by the mixture of primary colors. But the mixed yellow color is somber and the color is rather orange-like. Namely, it is very difficult to obtain a clear yellow color.

Further, the traffic alarm has plural lights, i.e., a blue light, a yellow light, a red light, a blue arrow mark light. By this arrangement, the weight of the traffic alarm is increased. Still more, it may be difficult to confirm the color of the alarm at a glance. When the alarm receives the sun beam, the beam may be reflected and make the alarm more indistinct.

To simplify the traffic alarm, it may be considered to utilize the LED device which can emit may colors by the mixture of the primary colors. But the yellow color or attention color is not clear, and by this reason the traffic alarm by above LED device is not realized.

### Means to Solve Subjects

This invention is to solve the above subject matters brought by the prior arts. By this invention, a single LED device emit plural colors by providing plural color emission chips in the cell. To utilize this multi-color LED device, the traffic alarm or the color image display is simple and having high performance.

Specially, by the application of the LED device to the traffic alarm, utilizing many LED devices of this invention to accomplish an alarm of single light. The lights include blue color light, yellow (orange) color light, red color light, and blue arrow mark light. In this invention the functions of above plural lights are achieved by common and single light. Further, blue arrow mark is shown on voluntary time by the devices in the circle of light or by utilizing a partial devices in the circle, indication of the direction by the arrow mark can be optionally shown.

The more concrete description of this invention are as follows.

(1) A LED device with plural color chips, characterized in that the device essentially includes a yellow color chip for emitting a singular yellow color beam which can not be obtained as a clear color by the mixture of the beams of plural color chips, and other color beam emitting chips.

(2) A LED device defined in term (1) wherein said other color beam emitting chips are red color chips and blue color chips.

(3) A LED device defined in term (1) wherein said other color beam emitting chips are primary color chips, i.e. red, green, and blue color chips.

(4) A LED device defined in term (2) wherein said device includes a circuit for emitting the blue color chip, yellow color chip, and red color chip regularly in order resulting in the three clear colors emission without mixture of the different color beam, and can be usable for light beam display of the traffic alarm.

(5) A color image display for color still image or color moving image, wherein many numbers of LED devices defined in term (3) are arranged and are controlled by the control circuit, respective LED device acts as a display element of the color display, and the emitting color by the color chips themselves and the mixture of the color beams by the plural color chips are clear color.

(6) A traffic alarm made of a singular light display which has a plural LED device defined in term (2), the LED device including a blue color chip (K·BL), a yellow color chip (K·YL), and a red color chips (K·RL).

(7) A traffic alarm made of a singular light display having plural numbers of LED device defined in term (2), and an arrow mark is formed in the light or a partial portion of the arrow mark is formed in the light for showing a blue direction indicating arrow mark.

### Technical Advantages of the Invention

According to a LED device with plural color chips, characterized in that the device essentially includes a yellow color chip for emitting a singular yellow color beam which can not be obtained as clear color by the mixture of the beams of plural color chips, and other color beam emitting chips, clear light beams can be obtained not only by respective singular color chips, but also clear light beams can be obtained by the mixture of the light beams of plural color chips even utilizing light emission diode (LED).

According to the LED device including yellow color chip, and other color beam emitting chips are red color chips and blue color chips, clear red, yellow, and blue light beams can be obtained by respective color chips, and reliable application to the traffic alarm can be accomplished by the three clear color beams.

According to the LED device including yellow color chip and other color beam emitting chips are primary color chips, i.e. red, green, and blue color chips, a clear yellow color which was not clear by the mixture of the primary color beams of the light emission diode can be obtained, and other many color beams can be obtained by the mixture of the three primary color chips, which accomplish a color image display having all clear colors display ability.

According to the LED device which includes a circuit for emitting the blue color chip, yellow color chip, and red color chip regularly in order resulting in the three clear colors without mixture of the different color beams, and can be usable for light beam display of the traffic alarm, by a single light made of plural LED devices of this invention, a traffic alarm of a simple apparatus which emits three essential alarm colors can be accomplished.

According to the color image display for color still image or color moving image, in which many numbers of LED devices are arranged and are controlled by the control circuit, respective LED device acts as a display element of the color display, and the emitting color by the color chips themselves and the mixture of the color beams by the plural color chips are clear color, a new color still and move display apparatus will be provided. The apparatus is bright and clear as to be adoptable to the outdoor advertising display, and electric power can be saved.

A traffic alarm made of a singular light display which has a plural LED devices and the LED device includes a blue color chip (K·BL), a yellow color chip (K·YL), and a red color chips (K·RL), a very simple traffic alarm can be manufactured.

A traffic alarm made of a singular light display having plural numbers of LED device, and an arrow mark is formed in the light or a partial portion of the arrow mark is formed in the light for showing a blue direction indicating arrow mark, a traffic alarm of a very simple structure can be provided, and the alarm can indicate the indication or the other information.

### PREFERRED EMBODIMENT OF THE INVENTION

A concrete embodiment of this invention will now be described referring to the drawings.

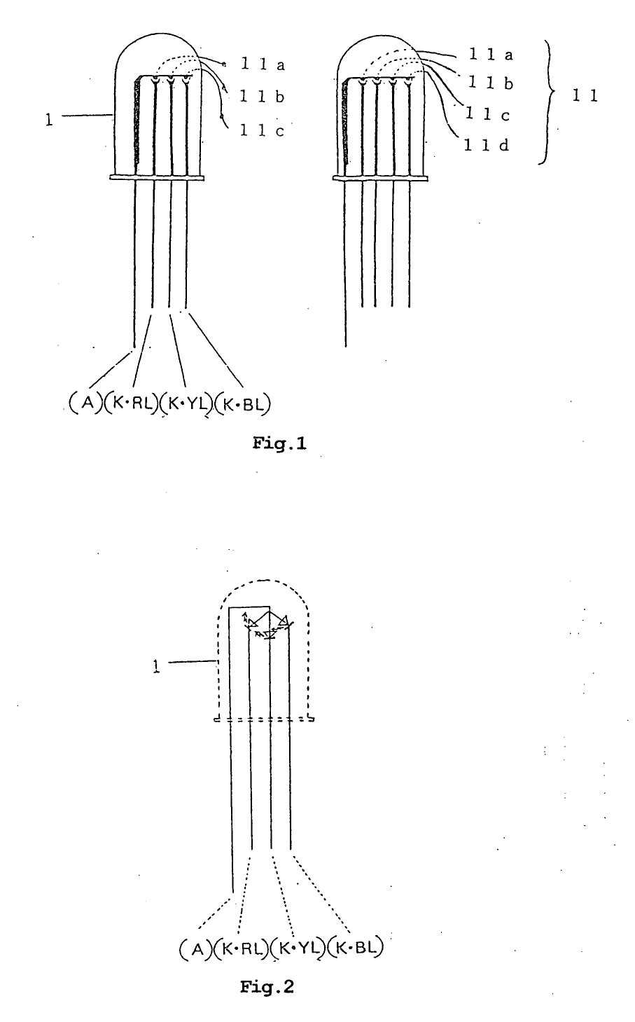

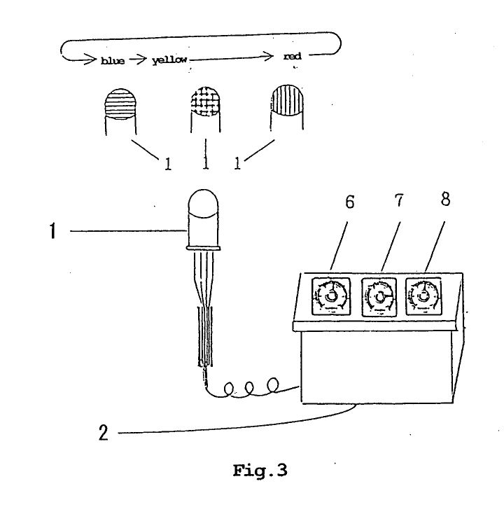

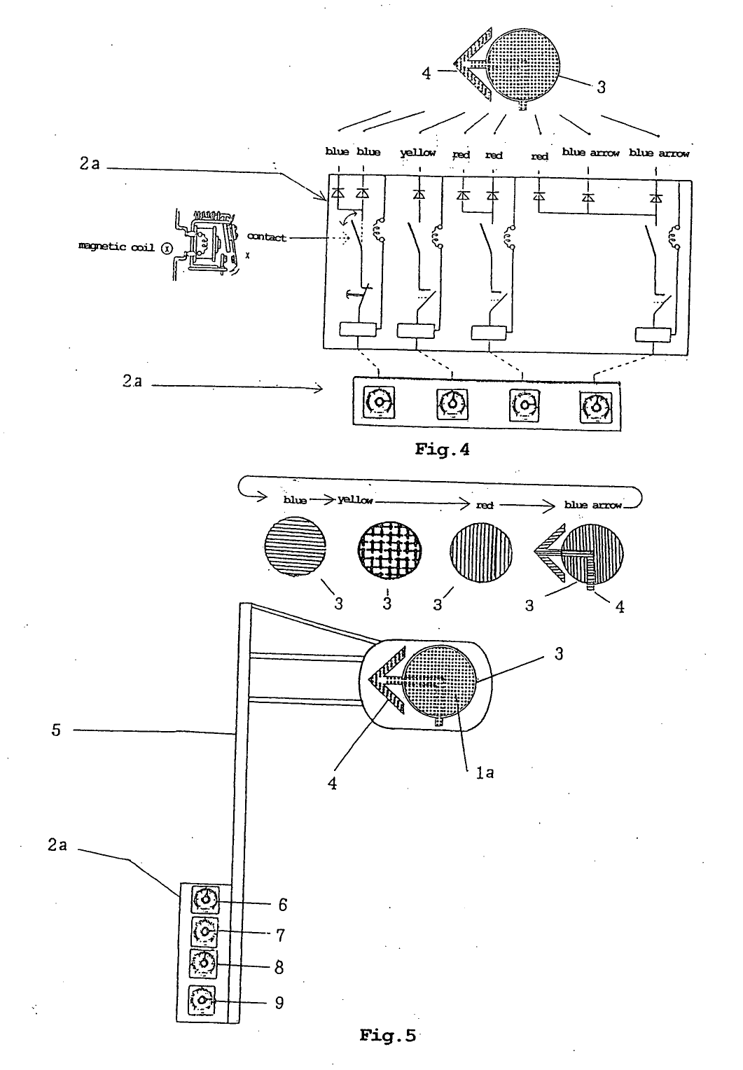

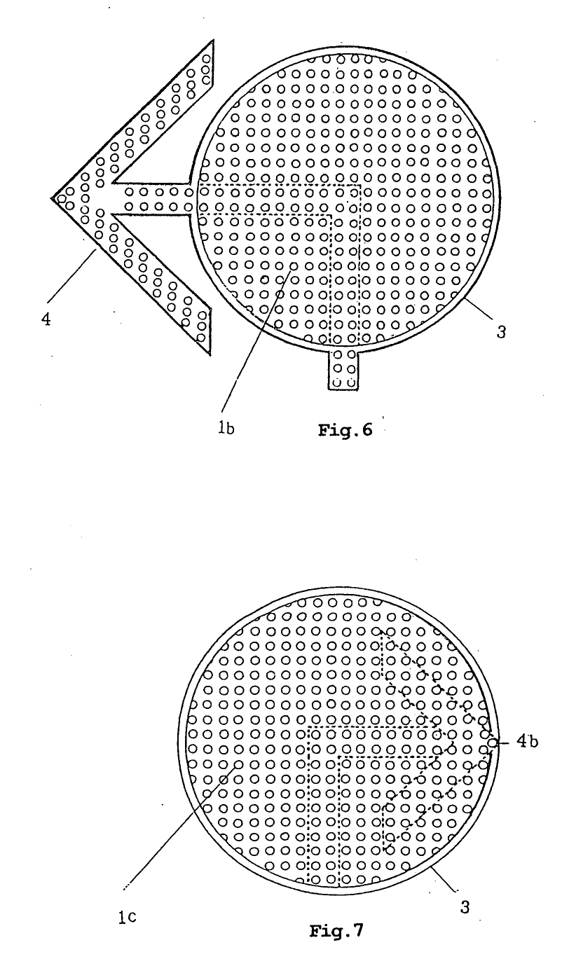

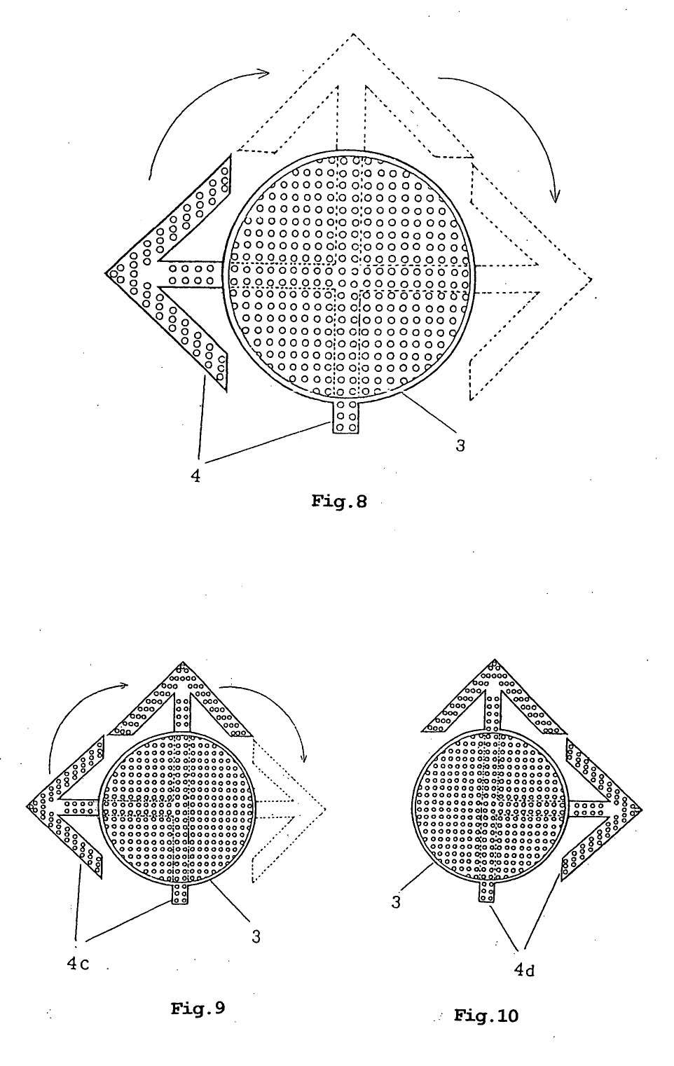

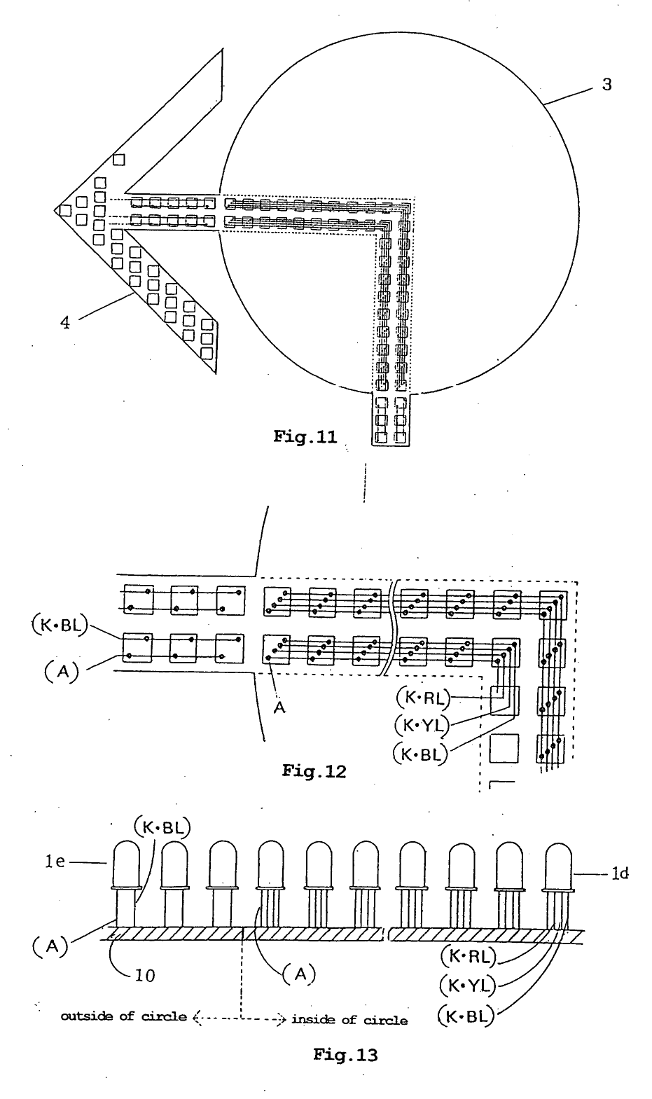

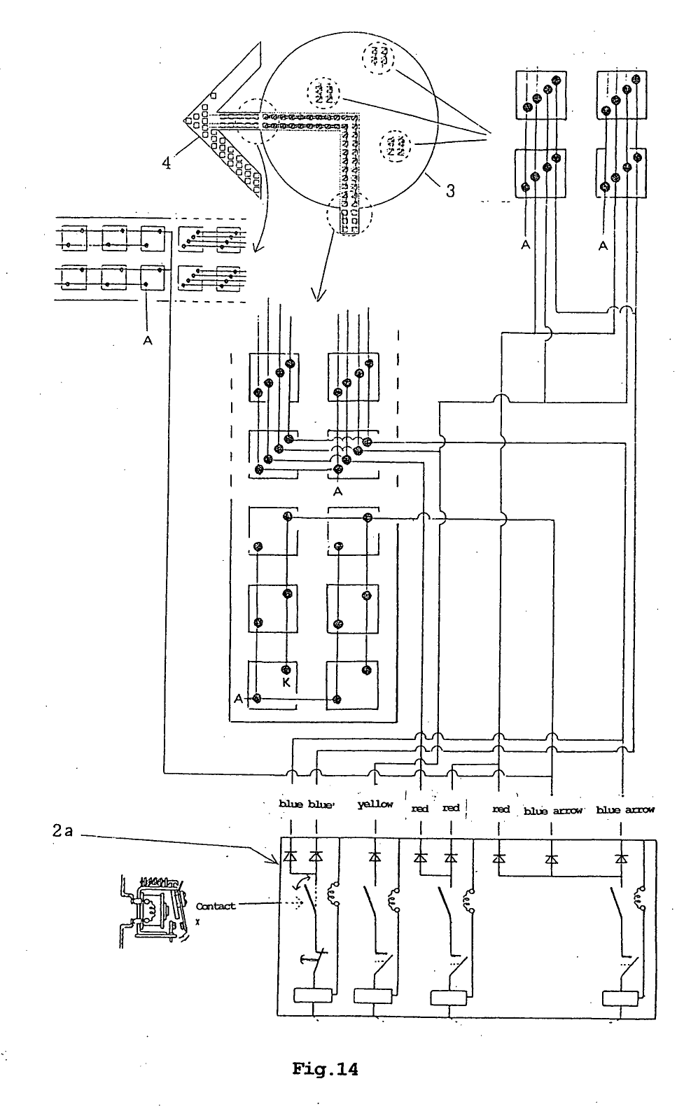

FIG. 1 shows a LED device in which three light source chips, i.e., a blue color chip (K·BL) 11c, a yellow color chip (K·YL) 11b, and a red color chips (K·RL) 11a are arranged. FIG. 1 further shows other LED device in which four light source chips, i.e., blue color chips (K·BL) 11c, a yellow color chips (K·YL) 11b, and a red color chips (K·RL) 11a, a green color chips (K·GL) are arranged.

A light or a display unit is manufactured from the plural of LED devices. The light or display unit is utilized as a light of a traffic alarm. All the functions of the traffic alarm including the indication of the direction by blue arrow mark can be performed by a singular light. The blue arrow mark is formed in the circle of the light or is formed partially in the circle of the light and the top of the arrow mark is projected outside of the circle of the light.

The color chips in the LED device emit blue beam, yellow beam, red beam, and blue beams forming arrow mark in order. When the arrow mark is formed from the blue color, the other portion in the light circle forms red color (or yellow color), and projected portion of the arrow mark projected from the circle of the light is blue color. In this case, the projected portion is made from the LED devices which have a blue color chip only.

The blue arrow mark can be formed in optional time, and to indicate optional direction.

The time differences of every color can be controlled by the dials 6, 7, 8, 9.

The circuit includes a timer for sequence control, having magnetic relays and magnetic contacts, thus resulting in the recognition of the operation. Diodes are connected to the device for preventing the reverse flow of electric current.

Rear side circuit is shown in FIG. 14. In this circuit, the LED devices are connected so that electric current of respective color is not supplied simultaneously to the same LED device.

The above mentioned embodiment explains an embodiment in which a traffic alarm is formed by a singular light with an arrow mark. When a yellow color chip is essentially provided, and further blue and red color chips are arranged in the LED device for single color element, the device may be utilized as a regular traffic alarm which does not include blue arrow mark.

Further, as mentioned above, according to the LED device which includes essentially the yellow color chip, and further three primary color chips, i.e., blue, red, and green color chips, any colors are obtained in principle by the mixture of primary three color, and yellow color, which is not clear when synthesized by mixture, is shown clear by exclusive color chip.

Accordingly, by a control of a singular LED device, all colors are clearly shown by an operational control of a single LED device. Hence, by a display made of many LED devices of this invention, a full color display apparatus can be accomplished. The display apparatus can show every color clearly and can be used for still and moving picture displays.

### INDUSTRIAL FIELD OF APPLICATION

The yellow color was not obtained clearly by the conventional mixture of three primary colors. According to the above mentioned invention, yellow color can surely and clearly be obtained. Further, as any colors can clearly be shown by a single LED device, a large-size color image display of LED device can be applied. Therefore, the display may be used as an outdoor advertising display.

Still more, this invention may be applied to a traffic alarm, in which blue, yellow, and red colors should be clearly shown. In this application, a clear color is accomplished by a simple structure. By high brightness of this alarm light, the color of the traffic alarm is instantaneously recognized at a glance, and error recognition will be prevented even though the sun beam is reflected. Still further, the weight of the traffic alarm will be lighten. The thickness of the light will be small, and hence dimension of the space for installing the traffic alarm will be minimized.

Accordingly, this invention will have a excellent application on industrial.

1. A light for a traffic alarm,
wherein said light includes plural LED devices which has three color element, i.e., a blue color chip (K·BL), a yellow color chip (K·YL), and a red color chips (K·RI),
the three color chips emit respective color beam in order by the sequential control means, and
a blue arrow mark is formed on said light when said light is red and partial portion of said arrow mark is formed from the LED devices of said light, and the top of the arrow mark is projected outside of said light by the arrangement of the LED devices outside of said light.

2. A light according to claim 1, wherein said light has a circular housing and said plural LED devices are arranged in the circle of said housing.

3. A light according to claim 2, wherein said partial portion of said arrow mark is formed by the LED devices arranged in said circle of the housing of light.

4. A light according to claim 2, wherein said top of the arrow mark is formed by the LED devices arranged outside of said circle of the housing.

5. A light according to claim 4, wherein the LED device arranged outside of said circle has blue color chip and not other color chips, while the LED device arranged inside of said circle has red color chip, blue color chip, and yellow color chip.
